(19) United States
(12) Patent Application Publication
(10) Pub. No.: US 2026/0124758 A1
(43) Pub. Date: May 7, 2026

(54) AUTOMATED METHOD TO SET PAYLOAD OF COLLABORATIVE ROBOT

(71) Applicant: FANUC America Corporation, Rochester Hills, MI (US)

(72) Inventors: Haochen Yu, Rochester Hills, MI (US); Jake Weinmann, Pontiac, MI (US); Ganesh Kalbavi, Rochester, MI (US)

(21) Appl. No.: 19/360,443

(22) Filed: Oct. 16, 2025

Related U.S. Application Data
(60) Provisional application No. 63/715,043, filed on Nov. 1, 2024.

(51) Int. Cl. B25J 9/16

(52) U.S. Cl. CPC B25J 9/1694

(57) ABSTRACT

A method and system for automatically setting a payload weight value for a collaborative robot, where one or more objects are picked up by a robot gripper, the weight of the objects is automatically determined by a force sensor and the weight is used for the payload, and the payload value is automatically adjusted when any of the objects is dropped off. Only one weight measurement is needed when all objects are known to be of the same weight, and objects of different weights can be handled with a weight measurement for each object. The system handles payload adjustment automatically without the need for manual adjustment or custom programming. The robot uses the payload weight value when detecting any externally applied force indicating contact with an operator or other object, and also for ensuring that payload accelerations do not exceed gripping force capacity or robot joint load limits.

### CROSS-REFERENCE TO RELATED APPLICATIONS

This application claims the benefit of the priority date of U.S. Provisional Patent Application Ser. No. 63/715,043, titled AUTOMATED METHOD TO SET PAYLOAD OF COLLABORATIVE ROBOT, filed Nov. 1, 2024.

### BACKGROUND

### Field

The present disclosure relates generally to the field of industrial robot control and, more particularly, to a method for automatically setting a payload weight value for a collaborative robot, where one or more objects are picked up by a robot gripper, the weight of the objects is automatically determined by a force sensor and the weight is used for the payload, and the payload value is automatically adjusted when any of the objects is dropped off.

### Discussion of the Related Art

The use of industrial robots to perform a wide range of manufacturing, assembly and material movement operations is well known. Many of these operations and tasks are performed by articulated robots, such as five-or six-axis robots with a servo motor at each rotational joint. Control of such robots is provided in real time, where a motion program is divided into small increments of motion, and a robot controller performs real-time feedback control calculations to compute joint motor input commands which move the robot end-of-arm tool center point along a prescribed trajectory.

One common type of robotic task is material movement, which involves moving packages or workpieces from an origin location to a destination location. A particular application of this type is where the robot is fitted with a vacuum gripper tool and the robot picks up packages (e.g., boxes) and moves them to a prescribed location. This type of robotic operation is commonly used for depalletizing or palletizing (i.e., moving boxes from a pallet to a conveyor, or vice versa).

In operations of the type described above, it is necessary to know the weight of the “payload”, or the objects which are being moved by the robot arm. The payload is typically considered to include the gripper (often a vacuum gripper of substantial weight) along with the box or boxes which are being carried by the gripper at any given time. The payload weight value is used for computing a robot end-of-arm trajectory and corresponding velocities and accelerations which maintain robot joint loads within prescribed limits, and which also prevent detachment of the box(es) from the vacuum gripper.

Certain applications dictate the use of collaborative robots, which are robots designed for use alongside a human operator in a workspace. Collaborative robots include control features for preventing forceful contact between the robot or its payload and the human operator. In collaborative robot applications, the payload weight value is used for establishing the control parameters which detect contact with any obstacle in the workspace, in addition to the trajectory calculation purposes described above.

Various methods have been used for setting a payload weight value for robots. In the simplest case, a robot only moves one box at a time, every box has the same weight, and the weight is known. In this case, the payload weight value is simply the weight of the gripper if the gripper is not carrying a box, or the weight of the gripper plus the known box weight if the gripper is carrying a box.

Most real applications are more complex, however, including boxes of various sizes and weights on a single pallet, and the need for the robot to pick up multiple boxes at the same time, drop off some of the boxes at one location and other boxes at other locations, and so forth. In applications such as this, determination of the payload weight value can be complicated and time-consuming.

One known technique for establishing a payload weight value is simply to measure the weight of all boxes being carried after each grasping or ungrasping operation. The weight measurement may be performed by a force sensor mounted on the robot arm proximal the vacuum gripper. The disadvantage of this technique is that the robot must stop after each grasp or ungrasp operation and the weight measurement then takes a certain amount of time. These measurement delays seriously reduce the productivity of the robot which is performing the package movement.

Even if box weights are known (all boxes having the same weight, or boxes of various known weights), most palletizing/depalletizing operations require the flexibility to grasp and ungrasp boxes in different numbers and combinations, depending on the makeup of particular pallets. For example, in one task the robot may need to grasp three boxes of different weights and drop them one at a time at different locations, and in the next task the robot may need to grasp four boxes of the same weight and drop them off in quantities of two, one and one. Each of these different task combinations requires a specific payload schedule, where each payload schedule identifies the payload weight value at each of the multiple steps of the task. This quickly leads to a proliferation of payload schedules, which are difficult to keep track of and which require complex custom programming for integration with the robot controller.

In light of the circumstances described above, there is a need for an improved method of setting a payload weight value without the need for defining payload schedules or custom programming, and with no unnecessary package weighing delays.

### SUMMARY

The present disclosure describes a method and system for automatically setting a payload weight value for a collaborative robot, where one or more objects are picked up by a robot gripper, the weight of the objects is automatically determined by a force sensor and the weight is used for the payload, and the payload value is automatically adjusted when any of the objects is dropped off. Only one weight measurement is needed when all objects are known to be of the same weight, and objects of different weights can be handled with a weight measurement for each object. The system handles payload compensation automatically without the need for payload schedules or custom programming. The robot uses the payload weight value when detecting any externally applied force indicating contact with an operator or other object, and also for ensuring that payload accelerations do not exceed gripping force capacity or robot joint load limits.

Additional features of the presently disclosed systems and methods will become apparent from the following description and appended claims, taken in conjunction with the accompanying drawings.

### BRIEF DESCRIPTION OF THE DRAWINGS

FIG. 1 is an illustration of an industrial robot fitted with a vacuum gripper tool, with a package attached to the vacuum gripper and being moved by the robot, as an example of an application which can benefit from the techniques of the present disclosure;

FIG. 2 includes illustrations of a pallet of many identical boxes and a pallet of boxes of different sizes and weights, further depicting examples of applications which can benefit from the techniques of the present disclosure;

FIG. 3 is a flowchart diagram of an existing technique for setting payload weight values using payload schedules in a robotic palletizing or depalletizing operation, as known in the art;

FIG. 4 is a flowchart diagram of a method for automatically setting a payload weight value for a robot picking and placing a single box, according to embodiments of the present disclosure; and

FIG. 5 is a flowchart diagram of a method for automatically setting a payload weight value for a robot picking and placing multiple boxes, according to embodiments of the present disclosure.

### DETAILED DESCRIPTION OF THE EMBODIMENTS

The following discussion of the embodiments of the disclosure directed to automatic payload setting for collaborative robots is merely exemplary in nature, and is in no way intended to limit the disclosed devices and techniques or their applications or uses.

Industrial robots are used for a variety of manufacturing, assembly and material movement operations. In one type of application, a robot is used to move a workpiece or a package from one location to another. A particular example of robotic package movement is known as depalletizing—where boxes are removed from a stack on a pallet and moved to a destination location such as a conveyor. The reverse operation—picking boxes from a conveyor and placing each box in a particular location on a pallet—is known as palletizing, and is also commonly employed.

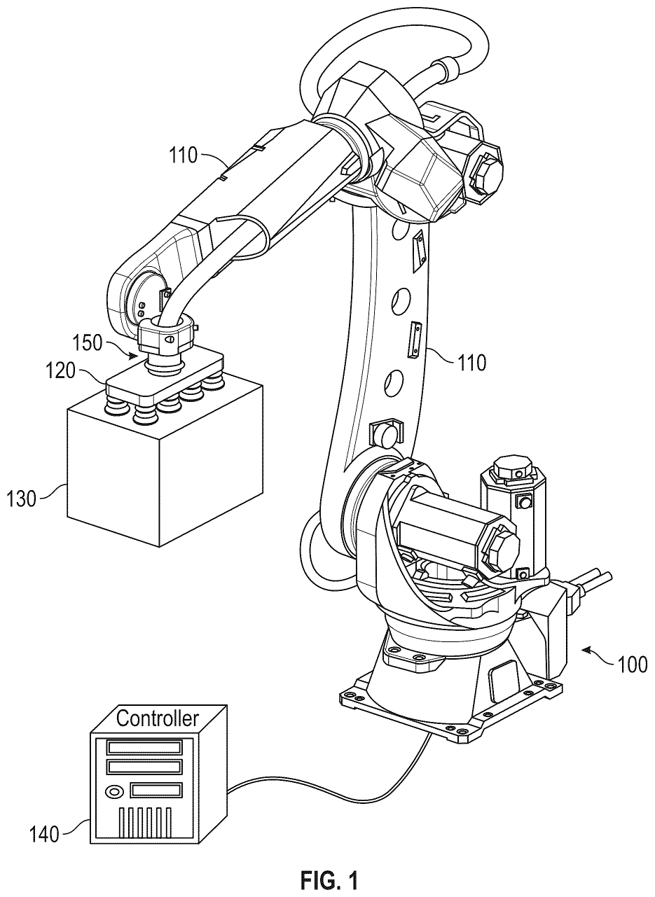

FIG. 1 is an illustration of an industrial robot 100 fitted with a vacuum gripper 120, with a package 130 attached to the vacuum gripper 120 and being moved by the robot 100, as an example of an application which can benefit from the techniques of the present disclosure. The robot 100 includes an articulated robot arm with multiple links 110, where the links 110 are coupled together at rotational joints which are actuated by servo motors, as known by those skilled in the art. The vacuum gripper 120 is the tool being used by the robot 100, where the vacuum gripper 120 is coupled to an outer arm link or wrist joint of the robot 100. The vacuum gripper 120 is a commonly used tool when the package 130 is a box, as illustrated in FIG. 1, or multiple boxes, as discussed below.

The robot 100 is in communication with a controller 140 in a manner known in the art—where the controller 140 provides joint motion commands to the robot 100, causing the robot 100 to move the vacuum gripper 120 to a target location where the package 130 is grasped, followed by motion commands causing the robot 100 to move the gripper 120 to a destination location where the package 130 is placed and released. When multiple boxes are grasped, they may be placed in different locations or all placed at the same location.

A load sensor 150 may be provided on the robot 100—such as at a location between the outer arm link 110 and the vacuum gripper 120 as shown. Other locations may be used for the load sensor 150 as suitable for a particular robot model, including integrating a load sensor into one of the arm links 110 such that the sensor is not outwardly visible. The load sensor 150 provides measurement values to the controller 140. In a typical palletizing/depalletizing operation, under static conditions, the force or load value measured by the sensor 150 is the weight of the gripper 120 and the box or boxes attached thereto (i.e., the package 130).

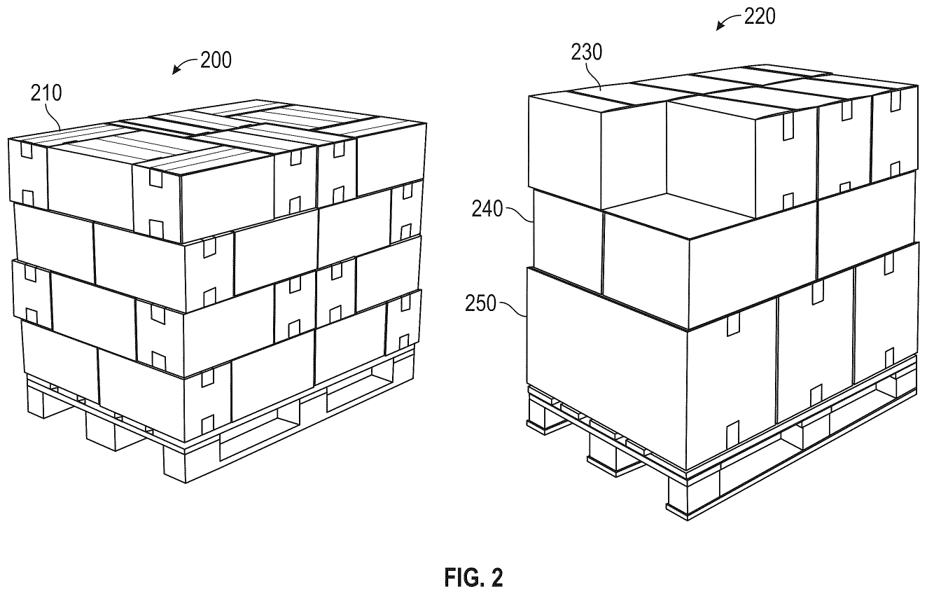

FIG. 2 includes illustrations of a pallet 200 containing many identical boxes and a pallet 220 containing boxes of different sizes and weights, further depicting examples of applications which can benefit from the techniques of the present disclosure. The pallet 200 contains a plurality of boxes 210, each of which is the same. The weight of each of the boxes 210 may or may not be known in advance. Note that each layer of the pallet 200 includes boxes in two different orientations, which is fairly common. The vacuum gripper on the robot arm can be rotated to pick up two boxes which are side by side in either orientation, or to pick up two boxes in one orientation and a third box in the other orientation, just to name some examples.

The pallet 220 contains a plurality of boxes of three different sizes and shapes—including several each of a box 230, a box 240 and a box 250. The pallet 220 is depicted with separate layers each containing only one particular size of box—but this is not necessarily the case. In mixed-size pallets, different package sizes may be placed on the same layer, and in fact parallel layers are not even necessarily present. In addition, mixed-size pallets may include boxes of the same size but different weights.

From FIG. 2 it is easy to visualize a depalletizing operation—where pallets such as the pallet 200 or the pallet 220 are presented to a robot which grasps boxes from the pallet and moves them elsewhere. As mentioned earlier, the techniques of the present disclosure discussed below are also applicable to palletizing operations, where boxes or other packages are picked from one location—such as a truck or a conveyor—and placed in particular locations and orientations on pallets which is being constructed.

Some palletizing and depalletizing operations like those discussed above are performed by an articulated robot which is mounted to a mobile base. The robot can thereby be moved to a desired location to perform a palletizing or depalletizing operation in proximity to a truck, loading dock, conveyor, etc. Some of these types of operations are carried out using collaborative robots in the presence of a human operator.

Accurately setting the payload weight value for robotic material movement operations is important for multiple reasons. First, the payload value is used in calculating robot trajectories and accelerations when moving objects from one location to another—where a heavy payload may necessitate reduced accelerations during the material movement in order to avoid exceeding the vacuum gripper's grasping capacity or robot joint load limits. Furthermore, the payload weight value is used in control of collaborative robot motion to detect contact between the robot or its payload and any obstacle—including the human operator. If the payload weight value is set too high, the collaborative robot might not stop as desired when accidental contact is made. If the payload weight value is set too low, the robot controller might interpret normal operational loads as indicative of contact, triggering a robot stop command. This requires the operator to then manually clear the fault in order to resume operations, which creates unnecessary robot downtime.

Robotic material movement operations such as palletizing and depalletizing are often performed in warehouses and on factory floors where a variety of items are handled. In other words, a robot might depalletize a few pallets of boxes from a truck where all of the boxes are the same size and weight, and the robot might subsequently be used to build a pallet from boxes of multiple sizes and weights arriving on a conveyor. This type of job task flexibility has, in the past, required that a large number of payload schedules be defined and programmed for the robot, where the appropriate payload schedule is selected for each particular task when it is commenced.

A payload schedule is a document or data table which defines the payload weight value for a particular combination of packages being carried by a vacuum gripper.

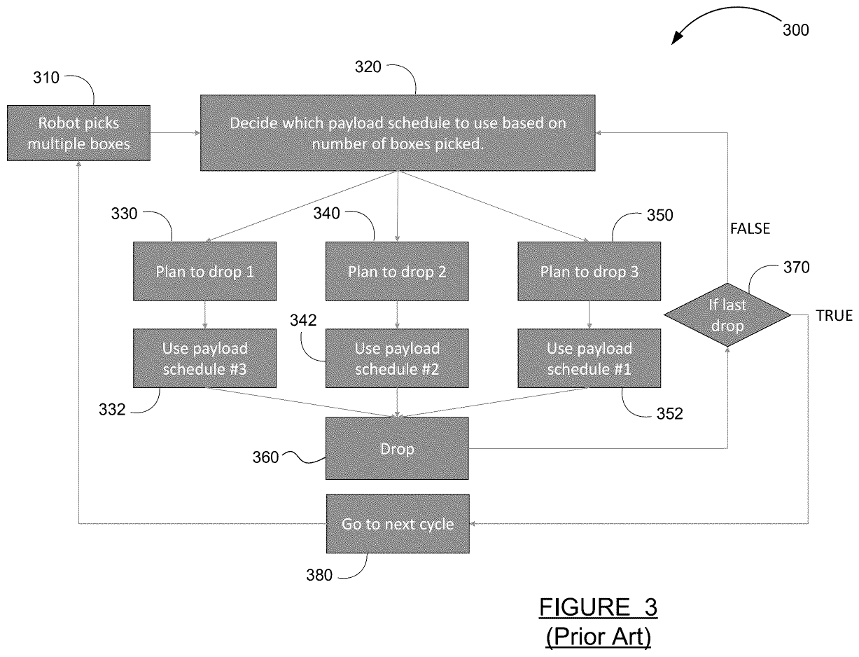

FIG. 3 is a flowchart diagram 300 of an existing technique for setting payload weight values using payload schedules in a robotic palletizing or depalletizing operation, as known in the art. At box 310, a robot with a vacuum gripper picks up multiple boxes from a pallet, conveyor or other source. In this example, the boxes are all of the same size and known weight. At box 320, a first step of payload schedule selection is performed based on the number of boxes picked. In this example, three boxes have been picked, so there are three optional paths for payload schedule selection depending on the plan for box drop-off.

At box 330, the plan is to drop one box (on a pallet or a conveyor, for example). Therefore, at box 332, a payload schedule identified as #3 is selected, where this payload schedule sets the payload based on a number of boxes, and after the drop-off resets the payload based on a new number of boxes which is reduced by one.

At box 340, the plan is to drop two boxes. Therefore, at box 342, a payload schedule identified as #2 is selected, where this payload schedule sets the payload based on a number of boxes, and after the drop-off resets the payload based on a new number of boxes which is reduced by two.

At box 350, the plan is to drop three boxes. Therefore, at box 352, a payload schedule identified as #1 is selected, where this payload schedule sets the payload based on a number of boxes, and after the drop-off resets the payload based on a new number of boxes which is reduced by three.

At box 360, the one or more boxes are dropped off in the designated location. The process then moves to decision diamond 370, where it is determined if the just-completed drop-off was the last drop-off for the current cycle (i.e., whether the gripper is now empty). If the gripper is not empty, the process returns to the box 320 where a new current number of boxes is set, and a new payload schedule is selected from one of the three paths based on the planned next drop quantity.

From the decision diamond 370, if the last drop value is true (i.e., the gripper is empty), then the process moves to box 380 where a next cycle is started by the robot picking multiple boxes at the box 310.

Even in the simple example of FIG. 3, it is apparent that payload schedules need to be developed and custom robot logic must be programmed to accommodate all anticipated combinations of box pick-up and drop-off sequences. A typical real-world palletizing/depalletizing operation using a modern industrial robot might be required to handle 20-30 different types of boxes, each having different sizes and weights. At the same time, the vacuum gripper can grasp up to 10 boxes at a time, which can then be dropped off in singles or multiples. These numbers of package weights and grasp/drop options create a very large number of combinations of possible payloads—where the number may be 200 or more. Using existing methods, each of these possible payloads must have a payload schedule defined, and custom robot programming must be created to integrate the payload schedules into the robotic operations in the manner depicted in FIG. 3. Managing all of this complexity is both labor-intensive and error-prone.

Another technique has been developed for setting payload weight values, without the need for complex payload schedules and programming. This technique involves measuring the weight of the payload after every pick or place operation, and setting the payload weight value accordingly. Although this technique is simple and flexible, it adds considerable delay time to the pick and place operation.

Consider an example where a robot picks four boxes and drops them off one at a time. In this example, the robot needs to measure box weights four times: 1) measure weight of four boxes at pick; 2) drop one box, measure remaining three boxes; 3) drop one box, measure remaining two boxes; 4) drop one box, measure remaining one box.

A typical industrial robot fitted with a vacuum gripper and a load sensor, as depicted in FIG. 1, requires about 1.8 seconds to accurately record a weight value. When a weight measurement is needed after every pick and place step, the measurement delays can add up to a significant and undesirable amount of time. In the example described above, with four measurement steps, the measurement delays add up to 7.2 seconds (4*1.8) per cycle. Considering that robots of this type can currently handle up to 10 boxes per pick cycle, the measurement delay could be as high as 18 seconds. These delays represent a serious detriment to robot productivity.

The techniques of the present disclosure have been developed to overcome the limitations of existing techniques, including both the need for complex payload schedules and integration programming, and the delays associated with measurement of payload weight at every step. These techniques are discussed below.

The payload compensation methods of the present disclosure incorporate several key concepts which increase robot productivity and reduce complexity. First, the disclosed methods eliminate payload schedule definition and custom programming by simply using either a full gripper payload or an empty gripper payload, where the full gripper payload is adjustable during package pick/place cycles. Next, the disclosed methods include a user configurable setting which designates whether a pick/place operation is moving boxes of consistent weight or differing weights. In addition, the disclosed methods provide automatic payload weighing by the robot-mounted load sensor, but only measure payload weight when needed, thereby eliminating many unnecessary measurement delays. The automatic weighing as necessary also eliminates the need for an external weighing apparatus such as a scale along with the incumbent creation of payload schedules based on the externally measured weights.

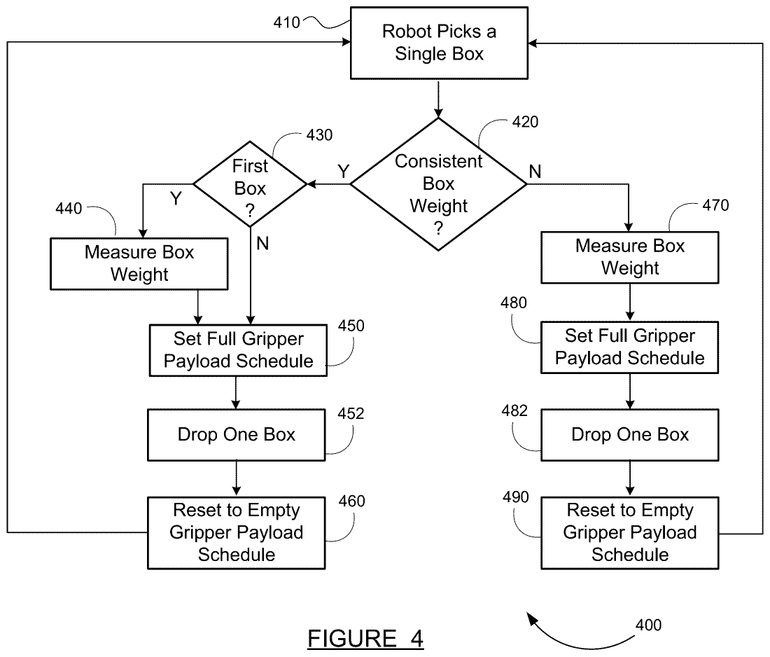

FIG. 4 is a flowchart diagram 400 of a method for automatically setting a payload weight value for a robot picking and placing a single box, according to embodiments of the present disclosure. At box 410, the robot picks a single box, such as from a conveyor, a bin or a pallet. At decision diamond 420, it is determined whether the boxes being handled have a consistent weight (all the same—such as the pallet 200 of FIG. 2) or not (at least two different weights—such as the pallet 220 of FIG. 2). The designation of consistent or inconsistent box weight is a user configurable setting which may be selected in a user interface screen on the robot controller (or a corresponding remote control device, teach pendant, etc.).

If all of the boxes have consistent weight, then at decision diamond 430 it is determined whether a currently picked box is the first box of the pick/place operation. For example, when picking the first box off of the pallet 200, the determination at the decision diamond 430 would be yes, it's the first box. Thereafter, for the remainder of the pallet 200 and any other pallets of that makeup, the determination at the decision diamond 430 is no.

If the determination at the decision diamond 430 is yes, it's the first box, then at box 440 the robot measures the box weight using the onboard load sensor (e.g., the load sensor 150 of FIG. 1). At box 450, the “full gripper payload schedule” is set, using the known empty gripper payload plus the weight of the box measured at the box 440. The full gripper payload schedule is used by the robot for the current pick/place cycle. At box 452, the box is dropped by the robot at a designated location—such as in a bin, on a pallet, on a conveyor, etc., depending on the requirements of the palletizing/depalletizing operation. After dropping off the one and only box, at box 460 the payload schedule is switched to the empty gripper payload schedule, which is defined in advance based on the weight of the gripper only. The process then loops back to the box 410 where the robot picks another box.

For each subsequent box picked, as long as the box weight is designated as consistent, the process moves from the decision diamond 430 directly to the box 450 where the full gripper payload schedule is selected using the same value as previously because the box weight is known to be the same. Thus, the box weight measurement at the box 440 is skipped, thereby avoiding unnecessary measurement delay.

If the boxes have inconsistent weights, then from the decision diamond 420 the process moves to box 470 where the robot measures the box weight using the onboard load sensor. At box 480, the full gripper payload schedule is set, using the known empty gripper payload plus the weight of the box measured at the box 470. The full gripper payload schedule is used by the robot for the current pick/place cycle. At box 482, the box is dropped by the robot at a designated location. After dropping off the one and only box, at box 490 the payload schedule is switched to the empty gripper payload schedule. The process then loops back to the box 410 where the robot picks another box. For each subsequent box picked, as long as the box weight is designated as inconsistent, the process moves from the decision diamond 420 to the box 470 where the new box weight is measured.

Still referring to FIG. 4, when the left side of the flowchart diagram is followed (consistent box weight), the disclosed method provides automatic measurement of box weight the first time, and then skips weight measurement for all subsequent cycles, which results in a significant time savings.

When the right side of the flowchart diagram 400 is followed (inconsistent box weight), the user simply has to designate the empty gripper payload and begin production operations. In contrast, using existing techniques, payload schedules must be defined for each possible box weight, those payload schedules must be integrated with control software using custom programming, and the correct payload schedule must be selected for each individual box picked by the robot.

From the above discussion, it is apparent that the disclosed automatic payload compensation method of the present disclosure provides advantages over existing methods—for both consistent box weight operations and inconsistent box weight operations.

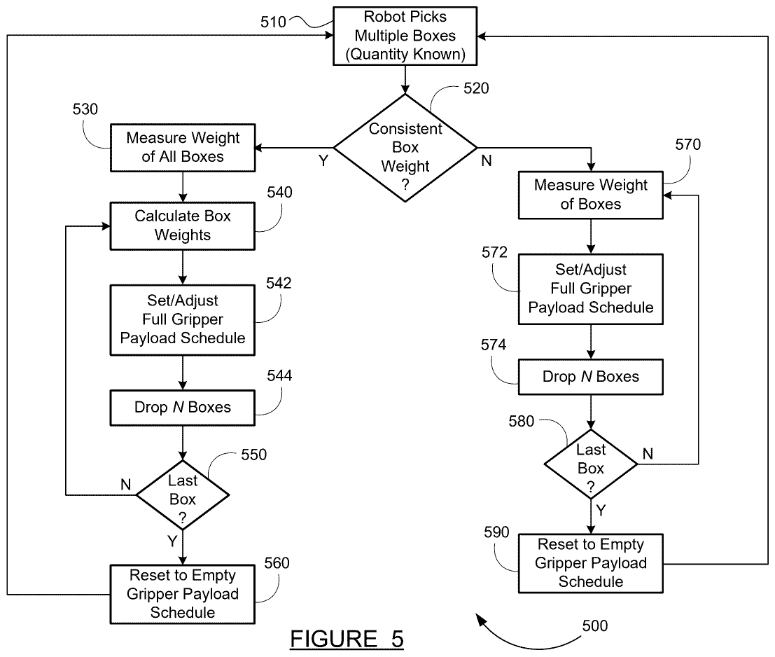

FIG. 5 is a flowchart diagram 500 of a method for automatically setting a payload weight value for a robot picking and placing multiple boxes, according to embodiments of the present disclosure. At box 510, the robot picks a plurality of boxes (from a conveyor, a bin or a pallet, etc.). The quantity of boxes picked at the box 510 is known.

At decision diamond 520, it is determined whether the boxes being handled have a consistent weight (all the same—such as the pallet 200 of FIG. 2) or not (at least two different weights—such as the pallet 220 of FIG. 2). The designation of consistent or inconsistent box weight is a user configurable setting which may be selected in a user interface screen on the robot controller (or a corresponding remote control device, teach pendant, etc.).

If all of the boxes have consistent weight, then at box 530 the robot measures the weight of all of the boxes using the onboard load sensor (e.g., the load sensor 150 of FIG. 1). At box 540, the weight of each individual box is calculated from the known empty weight of the gripper, the measured weight of all boxes from the box 530, and the known quantity of boxes. This is done by subtracting the empty gripper weight from the full gripper weight, and dividing the difference by the quantity of boxes.

At box 542, the “full gripper payload schedule” is set, using the known empty gripper payload plus the weight of the boxes currently grasped (which, the first time through, is equal to the weight measured at the box 530). The full gripper payload schedule is used by the robot for the current pick/place cycle until part of the payload is dropped off. At box 544, a known quantity of boxes is dropped by the robot at a designated location—such as in a bin, on a pallet, on a conveyor, etc., depending on the requirements of the palletizing/depalletizing operation. After dropping off one or more boxes, at decision diamond 550 it is determined whether the last box has been dropped off. If so, then at box 560 the payload schedule is switched to the empty gripper payload schedule, and the process then loops back to the box 510 where the robot picks another set of boxes.

From the decision diamond 550, if the gripper is not empty, the process returns to the box 540 to re-calculate the weight of the boxes currently being grasped. This is done by determining how many boxes remain attached to the gripper (the original quantity minus the quantity dropped off), multiplying by the known per-box weight, and adding this to the gripper weight. At box 542, the “full” gripper payload schedule is adjusted to the weight of the currently grasped boxes plus the gripper weight, and this payload value is used until more boxes are dropped off. After more boxes are dropped at the box 544, it is again determined at the decision diamond 550 whether the gripper is empty, and the process continues in this manner.

The process on the left side of FIG. 5 allows a multi-box payload (e.g., 8-10 boxes) to be dropped off in stages (e.g., two here, three there, etc.) without re-measuring the weight of remaining boxes, and without definition of any payload schedules. All of this is handled automatically as discussed above. In fact, as long as the box weight is designated as consistent, the measurement at the box 530 can be skipped after the first time, as the total box weight can be determined from the known per-box weight and the quantity of boxes grasped at the box 510.

If the boxes have inconsistent weights, then from the decision diamond 520 the process moves to box 570 where the robot measures the weight of the boxes using the onboard load sensor. At box 572, the full gripper payload schedule is set, using the known empty gripper payload plus the weight of the boxes measured at the box 570. Of course, if the measured weight at the box 570 includes the gripper along with the boxes, then that measured weight is used for the full gripper payload schedule. The full gripper payload schedule is used by the robot for the current pick/place cycle.

At box 574, a known quantity of boxes is dropped by the robot at a designated location. After dropping off one or more boxes, at decision diamond 580 it is determined whether the last box has been dropped off. If so, then at box 590 the payload schedule is switched to the empty gripper payload schedule, and the process then loops back to the box 510 where the robot picks another set of boxes.

From the decision diamond 580, if the gripper is not empty, the process returns to the box 570 to measure the weight of the boxes currently being grasped. At box 572, the “full” gripper payload schedule is adjusted to the weight of the currently grasped boxes plus the gripper weight, and this payload value is used until more boxes are dropped off. After more boxes are dropped at the box 574, it is again determined at the decision diamond 580 whether the gripper is empty, and the process continues in this manner.

When the right side of the flowchart diagram 500 is followed (inconsistent box weight), the user simply has to designate the empty gripper payload and begin production operations. In contrast, using existing techniques, payload schedules must be defined for each possible combination of box weights (of which there could be hundreds), those payload schedules must be integrated with control software using custom programming, and the correct payload schedule must be selected for each combination of boxes picked by the robot.

The discussion of FIG. 5 makes it is apparent that the advantages of the disclosed automatic payload compensation method apply to multi-box picking operations—for both consistent box weights and inconsistent box weights.

The automatic payload compensation techniques of the present disclosure may be advantageously applied to many types of robotic pick and place operations. These operations include palletizing and depalletizing (discussed extensively above), conveyor picking (boxes generally of unknown weight picked from a conveyor and placed on another conveyor, or a pallet or other location), bin picking (objects all of the same type in a bin, grasped and moved to another location) and “each picking” (objects of different types in a bin, grasped and moved individually to another location). In addition, the disclosed techniques are applicable to both collaborative and non-collaborative industrial robots.

Throughout the preceding discussion, various computers and controllers are described and implied. It is to be understood that the software applications and modules of these computers and controllers are executed on one or more electronic computing devices having a processor and a memory module. In particular, this includes one or more processors in the robot controller 140 discussed above. Specifically, the processors in the controller 140 are configured to perform the automatic payload compensation techniques described above.

While a number of exemplary aspects and embodiments of the methods and systems for automatic payload compensation have been discussed above, those of skill in the art will recognize modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for setting a payload weight value of an industrial robot, said method comprising:
providing a plurality of objects available for grasping;
grasping a quantity of the objects by a gripper fitted to the robot;
measuring a total weight of the quantity of objects, using a load sensor fitted to the robot or the gripper;
setting the payload weight value using the total weight of the quantity of objects and including a known empty gripper weight value;
when the grasped objects all have a same weight, determining a weight of each object as the total weight divided by the quantity, moving the gripper to a destination position, dropping off a subset of the quantity of objects, and reducing the payload weight value by an amount equal to a number of the objects dropped off multiplied by the weight of each object; and
when the grasped objects do not all have the same weight, moving the gripper to a destination position, dropping off a subset of the quantity of objects, measuring a new weight of a reduced quantity of objects using the load sensor, and setting the payload weight value using the new weight.

2. The method according to claim 1 further comprising dropping off a next subset of the quantity of objects and re-setting the payload weight value until the gripper is empty, whereupon the payload weight value is set to the empty gripper weight value.

3. The method according to claim 1 wherein, when the quantity of objects is one and all of the objects available for grasping have the same weight, grasping the one object, measuring the weight of only a first one of the objects, setting the payload weight value using the weight of the first one of the objects including the known empty gripper weight value, dropping off the one object, and repeating grasping and dropping off additional ones of the objects without measuring the weight of each of the additional ones.

4. The method according to claim 1 wherein, when the quantity of objects is one, and all of the objects available for grasping do not have the same weight, grasping the one object, measuring the weight of the one object, setting the payload weight value using the weight of the one object including the known empty gripper weight value, dropping off the one object, and repeating grasping and dropping off additional ones of the objects including measuring the weight of each of the additional ones.

5. The method according to claim 1 wherein the payload weight value is used in calculating a trajectory for movement of the objects by the robot, where the trajectory includes a spatial path of the gripper and velocity and acceleration profiles along the spatial path.

6. The method according to claim 5 wherein calculating a trajectory includes calculating robot joint loads and gripper-object forces based on the trajectory and the payload weight value and, when the robot joint loads or the gripper-object forces exceed corresponding predefined limits, recalculating the trajectory until the robot joint loads and the gripper-object forces do not exceed the limits.

7. The method according to claim 5 wherein the robot is a collaborative robot configured for operation with a human operator in proximity to the robot, and where the payload weight value is also used to establish a threshold value of an external force on the robot which triggers robot motion stoppage.

8. The method according to claim 1 wherein the robot is performing a palletizing or depalletizing operation by grasping and moving the objects.

9. The method according to claim 1 wherein the gripper is a vacuum gripper including a plurality of suction elements which are individually and selectively activatable, where each of the objects is grasped by activating one or more of the suction elements and released by deactivating the one or more of the suction elements.

10. The method according to claim 1 wherein a configuration parameter, indicating whether the objects available for grasping all have the same weight, is defined in advance of the grasping of the quantity of objects.

11. A method for setting a payload weight value of an industrial robot, said method comprising:
providing a plurality of objects available for grasping, where a configuration parameter is defined which indicates whether the objects available for grasping all have the same weight;
grasping a quantity of the objects by a gripper fitted to the robot, where the gripper is a vacuum gripper including a plurality of suction elements which are individually and selectively activatable, where each of the objects is grasped by activating one or more of the suction elements;
measuring a total weight of the quantity of objects, using a load sensor fitted to the robot or the gripper;
setting the payload weight value using the total weight of the quantity of objects and including a known empty gripper weight value;
when the grasped objects all have a same weight, determining a weight of each object as the total weight divided by the quantity, moving the gripper to a destination position, dropping off a subset of the quantity of objects, and reducing the payload weight value by an amount equal to a number of the objects dropped off multiplied by the weight of each object;
when the grasped objects do not all have the same weight, moving the gripper to a destination position, dropping off a subset of the quantity of objects, measuring a new weight of a reduced quantity of objects using the load sensor, and setting the payload weight value using the new weight; and
dropping off a next subset of the quantity of objects and re-setting the payload weight value until the gripper is empty, whereupon the payload weight value is set to the empty gripper weight value,
where the payload weight value is used in calculating a trajectory used to move the gripper to the destination position, where the trajectory includes a spatial path of the gripper and velocity and acceleration profiles along the spatial path.

12. The method according to claim 11 wherein, when the quantity of objects is one, grasping the one object, measuring the weight of the one object, setting the payload weight value using the weight of the one object including the known empty gripper weight value, dropping off the one object, and repeating grasping and dropping off additional ones of the objects, only measuring the weight of each of the additional ones of the objects when the objects available for grasping do not all have the same weight.

13. The method according to claim 11 wherein calculating a trajectory includes calculating robot joint loads and gripper-object forces based on the trajectory and the payload weight value and, when the robot joint loads or the gripper-object forces exceed corresponding predefined limits, recalculating the trajectory until the robot joint loads and the gripper-object forces do not exceed the limits.

14. The method according to claim 13 wherein the robot is a collaborative robot configured for operation with a human operator in proximity to the robot, and where the payload weight value is also used to establish a threshold value of an external force on the robot which triggers robot motion stoppage.

15. A robotic pick and place system with automatic payload compensation, said system comprising:
an industrial robot fitted with a gripper, and a load sensor coupled to the robot and/or the gripper; and
a robot controller in communication with the robot, the gripper and the load sensor, said controller configured to perform steps including;
grasping, from a plurality of objects available for grasping, a quantity of objects by the gripper;
measuring a total weight of the quantity of objects, using the load sensor;
setting the payload weight value using the total weight of the quantity of objects and including a known empty gripper weight value;
when the grasped objects all have a same weight, determining a weight of each object as the total weight divided by the quantity, moving the gripper to a destination position, dropping off a subset of the quantity of objects, and reducing the payload weight value by an amount equal to a number of the objects dropped off multiplied by the weight of each object; and
when the grasped objects do not all have the same weight, moving the gripper to a destination position, dropping off a subset of the quantity of objects, measuring a new weight of a reduced quantity of objects using the load sensor, and setting the payload weight value using the new weight.

16. The system according to claim 15 the controller is further configured for dropping off a next subset of the quantity of objects and re-setting the payload weight value until the gripper is empty, whereupon the payload weight value is set to the empty gripper weight value.

17. The system according to claim 15 wherein the controller is further configured for, when the quantity of objects is one and all of the objects available for grasping have the same weight, grasping the one object, measuring the weight of only a first one of the objects, setting the payload weight value using the weight of the first one of the objects including the known empty gripper weight value, dropping off the one object, and repeating grasping and dropping off additional ones of the objects without measuring the weight of each of the additional ones.

18. The system according to claim 15 wherein the controller is further configured for, when the quantity of objects is one, and all of the objects available for grasping do not have the same weight, grasping the one object, measuring the weight of the one object, setting the payload weight value using the weight of the one object including the known empty gripper weight value, dropping off the one object, and repeating grasping and dropping off additional ones of the objects including measuring the weight of each of the additional ones.

19. The system according to claim 15 wherein the payload weight value is used by the controller in calculating a trajectory for movement of the objects by the robot, where the trajectory includes a spatial path of the gripper and velocity and acceleration profiles along the spatial path.

20. The system according to claim 19 wherein calculating a trajectory includes calculating robot joint loads and gripper-object forces based on the trajectory and the payload weight value and, when the robot joint loads or the gripper-object forces exceed corresponding predefined limits, recalculating the trajectory until the robot joint loads and the gripper-object forces do not exceed the limits.

21. The system according to claim 20 wherein the robot is a collaborative robot configured for operation with a human operator in proximity to the robot, and where the payload weight value is also used to establish a threshold value of an external force on the robot which triggers the controller to stop robot motion.

22. The system according to claim 15 wherein the robot is performing a palletizing or depalletizing operation by grasping and moving the objects.

23. The system according to claim 15 wherein the gripper is a vacuum gripper including a plurality of suction elements which are individually and selectively activatable, where each of the objects is grasped by activating one or more of the suction elements and released by deactivating the one or more of the suction elements.

24. The system according to claim 15 wherein a configuration parameter, indicating whether the objects available for grasping all have the same weight, is defined in advance of the grasping of the quantity of objects.
